(19) United States
(12) Patent Application Publication
(10) Pub. No.: US 2025/0344199 A1
(43) Pub. Date: Nov. 6, 2025

(54) METHOD AND APPARATUS FOR INTELLIGENT LINK CONTROL IN WIRELESS COMMUNICATION SYSTEM

(71) Applicant: Electronics and Telecommunications Research Institute, Daejeon (KR)

(72) Inventors: Ji Hyung KIM, Daejeon (KR); Cheulsoon KIM, Daejeon (KR); Sung-Hyun MOON, Daejeon (KR); Junghoon LEE, Daejeon (KR); Hoiyoon JUNG, Daejeon (KR)

(21) Appl. No.: 19/197,866

(22) Filed: May 2, 2025

(30) Foreign Application Priority Data
May 3, 2024 (KR) 10-2024-0059463
Sep. 12, 2024 (KR) 10-2024-0125139

(51) Int. Cl. H04W 72/044; H04W 24/04

(52) U.S. Cl. CPC H04W 72/046; H04W 24/04

(57) ABSTRACT

A method of a user equipment (UE) may comprise: receiving, from a base station, first configuration information including a first transmission beam set; in response to a preconfigured condition being satisfied, receiving, from the base station, a reference signal (RS) through beams corresponding to the first transmission beam set; generating measurement information for the RS received through each of the beams corresponding to the first transmission beam set; generating a second transmission beam set based on the measurement information using an artificial intelligence (AI) model; and reporting information on the second transmission beam set to the base station, wherein the measurement information is an input of the AI model, and the second transmission beam set is generated through inference of the AI model.

### CROSS-REFERENCE TO RELATED APPLICATIONS

This application claims priority to Korean Patent Applications No. 10-2024-0059463, filed on May 3, 2024, and Korean Patent Applications No. 10-2024-0125139, filed on Sep. 12, 2024, with the Korean Intellectual Property Office (KIPO), the entire contents of which are hereby incorporated by reference.

### BACKGROUND

### 1. Technical Field

The present disclosure relates to a link control technique in a wireless communication system, and more particularly, to an intelligent link control technique in a wireless communication system.

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g. Long Term Evolution (LTE) communication system or LTE-Advanced (LTE-A) communication system), the 5th generation (5G) communication system (e.g. new radio (NR) communication system) that uses a frequency band (e.g. a frequency band of 6 GHz or above) higher than that of the 4G communication system as well as a frequency band of the 4G communication system (e.g. a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

Such a wireless communication system may be designed in consideration of various scenarios, service requirements, and potential system compatibility. In particular, discussions on beam-based communication in a 5G NR communication system may be active in order to perform broadband communication in a high-frequency band. Accordingly, beam-based communication may be used continuously. In addition, the communication system may enhance performance by utilizing artificial intelligence (AI)/machine learning (ML). Therefore, a link control method and device utilizing AI/ML are required in the wireless communication system.

### SUMMARY

The present disclosure for resolving the above-described problems is directed to providing an intelligent link control method and apparatus in a wireless communication system.

A method of a user equipment (UE), according to an exemplary embodiment of the present disclosure, may comprise: receiving, from a base station, first configuration information including a first transmission beam set; in response to a preconfigured condition being satisfied, receiving, from the base station, a reference signal (RS) through beams corresponding to the first transmission beam set; generating measurement information for the RS received through each of the beams corresponding to the first transmission beam set; generating a second transmission beam set based on the measurement information using an artificial intelligence (AI) model; and reporting information on the second transmission beam set to the base station, wherein the measurement information is an input of the AI model, and the second transmission beam set is generated through inference of the AI model.

The method may further comprise: receiving downlink transmission beam information from the base station; and receiving a downlink channel from the base station based on the downlink transmission beam information, wherein the downlink transmission beam information indicates one or more beams selected from beams based on the information on the second transmission beam set.

The downlink transmission beam information may be indicated based on transmission configuration indication (TCI) information.

The preconfigured condition may be satisfied at least one of: when an initial access procedure is initiated, when synchronization between the UE and the base station is required, when a beam recovery procedure is initiated, when a radio resource control (RRC) connection establishment procedure is initiated, when an RRC reconfiguration is initiated, or when there is a request from the base station.

The first configuration information may further include at least one of: a time for each of inference values output by the AI model, a time interval between the inference values, a reference time of a first inference value among the inference values output by the AI model, or a reference time of a last inference value among the inference values output by the AI model.

The first configuration information may further include at least one of: an inference start time of the AI model, an inference end time of the AI model, an inference duration of the AI model, or a reference value for monitoring inference of the AI model.

When the first configuration information includes a plurality of first transmission beam sets, and activation indication information for one first transmission beam set among the plurality of first transmission beam sets is received, an RS may be received from the base station through beams corresponding to the one first transmission beam set, and the AI model may be an AI model corresponding to the one first transmission beam set indicated by the activation indication information among AI models configured by the first configuration information.

The method may further comprise: in response to receipt of deactivation indication information of the AI model corresponding to the one first transmission beam set for which the activation indication information is received, stopping the inference of the AI model.

When the measurement information, which is the input of the AI model, includes measurement values obtained using the AI model, the measurement information may be determined based on a valid duration for the measurement values of the AI model, which is included in the first configuration information.

The first configuration information may be determined in a UE-specific manner or in a manner specific to a UE group using a same AI.

A method of a base station, according to an exemplary embodiment of the present disclosure, may comprise: transmitting, to a user equipment (UE), first configuration information including a first transmission beam set; in response to a preconfigured condition being satisfied, transmitting a reference signal (RS) to the UE through beams corresponding to the first transmission beam set; receiving, from the UE, information on a second transmission beam set; transmitting, to the UE, information on a downlink transmission beam determined based on the second transmission beam set; and transmitting a downlink channel to the UE through the determined downlink transmission beam.

The downlink transmission beam information may be indicated based on transmission configuration indication (TCI) information.

The first configuration information may further include at least one of: a time for each of inference values output by the AI model, a time interval between the inference values, a reference time of a first inference value among the inference values output by the AI model, or a reference time of a last inference value among the inference values output by the AI model.

The method may further comprise: when the first configuration information includes a plurality of first transmission beam sets, and AI models are respectively configured for the plurality of first transmission beam sets, transmitting activation indication information for one first transmission beam set among the plurality of first transmission beam sets.

The first configuration information may be determined in a UE-specific manner or in a manner specific to a UE group using a same AI.

A user equipment (UE) according to an exemplary embodiment of the present disclosure may comprise at least one processor, wherein the at least one processor may cause the UE to perform: receiving, from a base station, first configuration information including a first transmission beam set; in response to a preconfigured condition being satisfied, receiving, from the base station, a reference signal (RS) through beams corresponding to the first transmission beam set; generating measurement information for the RS received through each of the beams corresponding to the first transmission beam set; generating a second transmission beam set based on the measurement information using an artificial intelligence (AI) model; and reporting information on the second transmission beam set to the base station, wherein the measurement information is an input of the AI model, and the second transmission beam set is generated through inference of the AI model.

The at least one processor may further cause the UE to perform: receiving downlink transmission beam information from the base station; and receiving a downlink channel from the base station based on the downlink transmission beam information, wherein the downlink transmission beam information indicates one or more beams selected from beams based on the information on the second transmission beam set.

The preconfigured condition may be satisfied at least one of: when an initial access procedure is initiated, when synchronization between the UE and the base station is required, when a beam recovery procedure is initiated, when a radio resource control (RRC) connection establishment procedure is initiated, when an RRC reconfiguration is initiated, or when there is a request from the base station.

The first configuration information may further include at least one of: a time for each of inference values output by the AI model, a time interval between the inference values, a reference time of a first inference value among the inference values output by the AI model, or a reference time of a last inference value among the inference values output by the AI model.

The first configuration information may further include at least one of: an inference start time of the AI model, an inference end time of the AI model, an inference duration of the AI model, or a reference value for monitoring inference of the AI model.

According to exemplary embodiments of the present disclosure, an AI/ML-based radio link control method can be provided. According to the present disclosure, beam sets to which AI/ML is applied can be determined differently or identically according to training and inference. According to exemplary embodiments of the present disclosure, AI/ML models corresponding to the beam sets can be efficiently determined as models required for training and inference. According to exemplary embodiments of the present disclosure, a training time and/or an inference time of the AI/ML model may be configured, and a start and end of training and/or inference may be indicated through activation and deactivation of the AI/ML model. A downlink channel can be transmitted through a beam determined by training and inference of the AI/ML model, and the determined beam can be indicated based on transmission configuration indication (TCI) information.

### BRIEF DESCRIPTION OF DRAWINGS

FIG. 1 is a conceptual diagram illustrating an exemplary embodiment of a communication system.

FIG. 2 is a block diagram illustrating an exemplary embodiment of a communication node constituting a communication system.

FIG. 3 is a conceptual diagram illustrating a functional framework for RAN intelligence using artificial intelligence (AI)/machine learning (ML).

FIG. 4 is a conceptual diagram illustrating an example of an AI/ML framework according to an exemplary embodiment of the present disclosure.

FIG. 5 is a sequence chart illustrating a beam management procedure between a base station and a terminal when the base station performs inference in a mobile communication system.

FIG. 6 is a sequence chart illustrating a beam management procedure between a base station and a terminal when the terminal performs inference in a mobile communication system.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may have the same meaning as a communication network.

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced network, 5G mobile communication network, beyond 5G (B5G) mobile communication network (e.g. 6G mobile communication network), or the like.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present specification, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

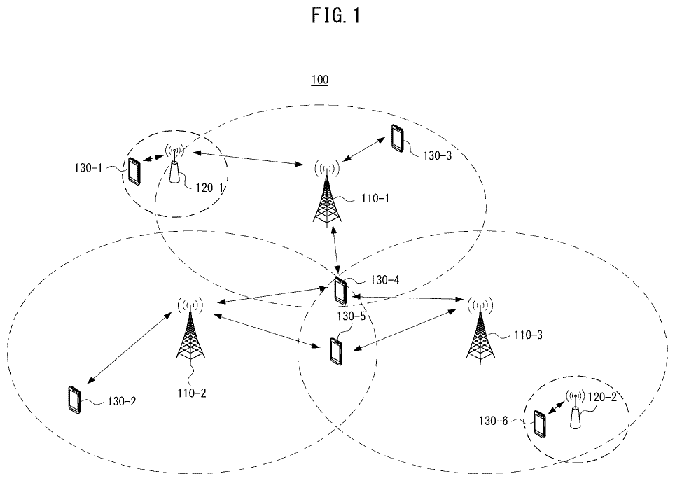

FIG. 1 is a conceptual diagram illustrating an exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4G communication (e.g. long term evolution (LTE), LTE-advanced (LTE-A)), 5G communication (e.g. new radio (NR)), 6G communication, etc. specified in the 3rd generation partnership project (3GPP) standards. The 4G communication may be performed in frequency bands below 6 GHz, and the 5G and 6G communication may be performed in frequency bands above 6 GHz as well as frequency bands below 6 GHz.

For example, in order to perform the 4G communication, 5G communication, and 6G communication, the plurality of communication may support a code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform spread OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter bank multi-carrier (FBMC) based communication protocol, universal filtered multi-carrier (UFMC) based communication protocol, space division multiple access (SDMA) based communication protocol, orthogonal time-frequency space (OTFS) based communication protocol, or the like.

Further, the communication system 100 may further include a core network. When the communication 100 supports 4G communication, the core network may include a serving gateway (S-GW), packet data network (PDN) gateway (P-GW), mobility management entity (MME), and the like. When the communication system 100 supports 5G communication or 6G communication, the core network may include a user plane function (UPF), session management function (SMF), access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

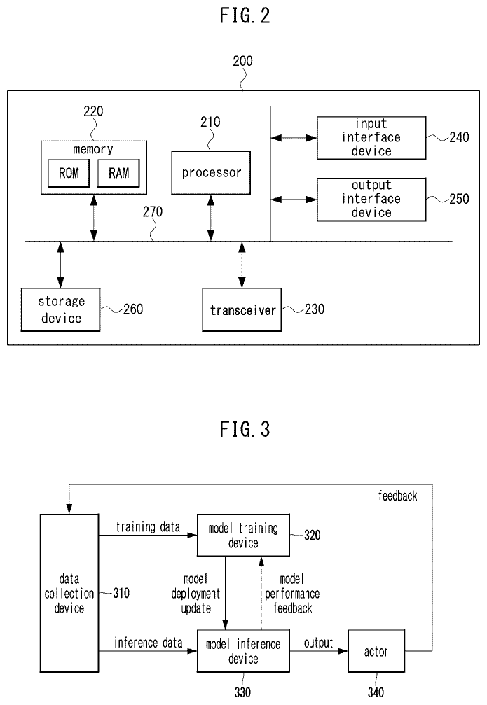

FIG. 2 is a block diagram illustrating an exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B (NB), evolved Node-B (eNB), gNB, base transceiver station (BTS), radio base station, radio transceiver, access point, access node, road side unit (RSU), radio remote head (RRH), transmission point (TP), transmission and reception point (TRP), or the like.

Each of the plurality of terminals 130-1, 130-2, 130-3, 130-4, 130-5, and 130-6 may refer to a user equipment (UE), terminal, access terminal, mobile terminal, station, subscriber station, mobile station, portable subscriber station, node, device, Internet of Thing (IT) device, mounted module/device/terminal, on-board device/terminal, or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support multi-input multi-output (MIMO) transmission (e.g. a single-user MIMO (SU-MIMO), multi-user MIMO (MU-MIMO), massive MIMO, or the like), coordinated multipoint (CoMP) transmission, carrier aggregation (CA) transmission, transmission in an unlicensed band, device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the COMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, methods for configuring and managing radio interfaces in a communication system will be described. Even when a method (e.g. transmission or reception of a signal) performed at a first communication node among communication nodes is described, the corresponding second communication node may perform a method (e.g. reception or transmission of the signal) corresponding to the method performed at the first communication node. That is, when an operation of a terminal is described, a corresponding base station may perform an operation corresponding to the operation of the terminal. Conversely, when an operation of a base station is described, a corresponding terminal may perform an operation corresponding to the operation of the base station.

Meanwhile, in a communication system, a base station may perform all functions (e.g. remote radio transmission/reception function, baseband processing function, and the like) of a communication protocol. Alternatively, the remote radio transmission/reception function among all the functions of the communication protocol may be performed by a transmission and reception point (TRP) (e.g. flexible (f)-TRP), and the baseband processing function among all the functions of the communication protocol may be performed by a baseband unit (BBU) block. The TRP may be a remote radio head (RRH), radio unit (RU), transmission point (TP), or the like. The BBU block may include at least one BBU or at least one digital unit (DU). The BBU block may be referred to as a ‘BBU pool’, ‘centralized BBU’, or the like. The TRP may be connected to the BBU block through a wired fronthaul link or a wireless fronthaul link. The communication system composed of backhaul links and fronthaul links may be as follows. When a functional split scheme of the communication protocol is applied, the TRP may selectively perform some functions of the BBU or some functions of medium access control (MAC)/radio link control (RLC) layers.

FIG. 3 is a conceptual diagram illustrating a functional framework for RAN intelligence using artificial intelligence (AI)/machine learning (ML).

Referring to FIG. 3, a functional framework for RAN intelligence using AI/ML may include a data collection device 310, a model training device 320, a model inference device 330, and an actor 340. In the following description, AI/ML may refer to only AI or only ML. However, this is merely for convenience of description, and even when AI or ML alone is referred to, it should be understood as AI and/or ML. The exemplary embodiment of FIG. 3 below describes an AI/ML functionality configuration based on an AI/ML model configured according to an AI/ML algorithm and an AI/ML-based beam management method according to inputs and outputs corresponding to the AI/ML model.

The data collection device 310 may be a device that collects data for updating the AI model in offline and/or online manner. Although FIG. 3 does not illustrate a method of collecting data for updating the AI model in the offline manner, the data collection device 310 may receive offline data from an operator, an external device, or a separate network. In the example of FIG. 3, a procedure is illustrated in which the data collection device 310 receives feedback information online from the actor 340.

The data collection device 310 may be an entity that provides input data to the model training device 320 and the model inference device 330. The data input by the data collection device 310 to the model training device 320 and the model inference device 330 may be data classified from offline data and/or online data as described above. The online data may include at least one of feedback values from another entity in the network, such as the actor 340, and feedback values for outputs of the AI/ML model.

More specifically, the data provided by the data collection device 310 to the model training device 320 may be training data. The training data may be data provided for training the AI/ML model. Inference data provided by the data collection device 310 to the model inference device 330 may be data provided for the AI/ML model inference function.

The model training device 320 may be an entity that performs training, validation, and/or testing of the AI/ML model. The model training device 320 may generate performance metrics for the AI/ML model through training, validation, and testing of the AI/ML model. The model training device 320 may update the AI/ML model based on the generated performance metrics. In other words, the model training device 320 may provide the updated AI/ML model to the model inference device 330 through a model deployment update procedure.

The model inference device 330 may infer the performance of the AI/ML model provided by the model training device 320 and may provide an inference result to the model training device 320 through a model performance feedback procedure. The model inference device 330 may perform inference using the inference data provided by the data collection device 310 when inferring the performance of the AI/ML model provided by the model training device 320. The procedure in which the model inference device 330 provides feedback on the performance of the AI/ML model to the model training device 320 may be used optionally. To indicate that the procedure for providing feedback on the performance of the AI/ML model is used optionally, in FIG. 3, the model performance feedback is depicted with a dotted line. However, the present disclosure is described under the assumption that the model performance feedback is performed.

The model training device 320 may additionally perform training, validation, and/or testing of the AI/ML model based on the performance of the AI/ML model provided from the model inference device 330 through the model performance feedback procedure. The model training device 320 may further generate performance metrics for the AI/ML model through the additional training, validation, and testing of the AI/ML model. The model training device 320 may update the AI/ML model again based on the additionally generated performance metrics. Thereafter, the model training device 320 may again provide the updated AI/ML model to the model inference device 330.

Meanwhile, the model inference device 330 may receive the inference data from the data collection device 310 and may perform inference on the AI/ML model provided by the model training device 320. When an inference result indicates that the AI/ML model provided by the model training device 320 is appropriate, the model inference device 330 may provide (or output) the AI/ML model to the actor 340.

The actor 340 may be communication node(s) constituting the functional framework for RAN intelligence using AI/ML. In another example, the actor 340 may be a specific device to which AI/ML is applied. For example, the actor 340 may be a channel noise canceller described later in the present disclosure. In another example, the actor 340 may be a device that generates feedback information based on an output of the channel noise canceller described later in the present disclosure.

The actor 340 may operate by applying the received AI/ML model and may provide an operation result as feedback information to the data collection device 310.

Generally, in a RAN, since the AI/ML model is provided by the base station to the terminal, the actor 340 may be assumed to be a terminal. In the configuration of FIG. 3, the remaining components excluding the actor 340 may be located in the base station and/or a higher-level network including the base station.

As described above with reference to FIG. 3, learning (or training) of the AI/ML model may be performed by the model training device 320 using the training data. The AI/ML model trained by the model training device 320 may be provided to the model inference device 330. The model inference device 330 may perform inference on the trained AI/ML model using the inference data provided by the data collection device 310 and may provide feedback on the inference result to the model training device 320 through the model performance feedback procedure. Therefore, the model training device 320 may update the AI/ML model by additionally reflecting the inference result and may provide the updated AI/ML model again to the model inference device 330.

The model inference device 330 may perform inference again on the updated AI/ML model based on the inference data and, when the inference result is appropriate, may provide the updated AI/ML model to the actor 340. The actor 340 may apply the updated AI/ML model. The actor 340 may apply the AI/ML model in an actual communication environment and may provide a result to the data collection device 310 as feedback. This procedure may be repeated and applied. Therefore, the AI/ML model may be continuously updated.

A form in which the AI/ML model described in FIG. 3 is applied in the RAN may vary. For example, the data collection device 310, the model training device 320, and the model inference device 330 may be included in the base station, and the actor 340 may be included in the terminal. In another example, the data collection device 310, the model training device 320, and the model inference device 330 may be included in a higher-level network including the base station (or a separate network for providing AI/ML data), and the actor 340 may be included in the terminal. In yet another example, the data collection device 310, the model training device 320, the model inference device 330, and the actor 340 may each be included in both the base station and the terminal.

The base station may perform management on beams for allocation to the terminal based on the AI/ML model. In this case, candidate beam information, measurement information of beams, movement path information of the terminal, and/or other information may be input as inference data to the model inference device 330. The model inference device 330 may determine suitability of the AI/ML model based on the inference data. Accordingly, the actor 340 to which the selected AI/ML model is applied may provide information on the result of applying the AI/ML model as feedback.

Hereinafter, AI, which is one of the core implementation techniques of a next-generation mobile communication system, is described. In the following description, a sixth generation (6G) system is presented as an example of a next-generation mobile communication system. However, methods/technical features proposed in the present disclosure are not limited to the 6G system. In other words, the methods described below may also be applicable to a 5G mobile communication system when AI techniques are used.

AI is the most important and newly introduced technique in the 6G system. AI was not integrated into 4G systems. The 5G system may support partial or very limited AI. However, the 6G system may support AI for full automation. The advancement of ML may create a more intelligent network for real-time communication in 6G. When AI is introduced into a mobile communication system, real-time data transmission may be simplified and improved. AI may determine a scheme in which complex target tasks are performed by using numerous analyses. In other words, AI may improve efficiency and reduce processing delay.

For example, time-consuming tasks such as handover, network selection, and resource scheduling may be performed instantly by using AI. AI may also play an important role in machine-to-machine (M2M), machine-to-human, and human-to-machine communication. In addition, AI may enable rapid communication through brain-computer interfaces (BCIs). AI-based communication systems may be supported by metamaterials, intelligent structures, intelligent networks, intelligent devices, intelligent cognitive radios, self-sustaining wireless networks, and machine learning.

Recently, although there have been attempts to integrate AI into wireless communication systems, these efforts have mainly focused on the application layer and the network layer, with deep learning efforts being concentrated in the field of wireless resource management and allocation. However, such research is gradually advancing to a media access control (MAC) layer and the physical layer. In particular, there are emerging attempts to combine deep learning with wireless transmission at the physical layer. AI-based physical layer transmission may refer to applying a signal processing and communication mechanism based on an AI driver, rather than a traditional communication framework, in fundamental signal processing and communication mechanisms. For example, applying the signal processing and communication mechanism based on the AI driver may include deep learning-based channel coding and decoding, deep learning-based signal estimation and detection, deep learning-based multiple input multiple output (MIMO) mechanism, and AI-based resource scheduling and allocation.

Machine learning may be used for channel estimation and channel tracking, and may be used for power allocation and interference cancellation at the physical layer of a downlink (DL). Machine learning may also be used in MIMO systems for antenna selection, power control, and symbol detection.

In order to apply AI/ML as described above, deep neural networks (DNN) may be used. However, the following issues may arise in applying DNN for transmission at the physical layer.

First, a deep learning-based AI algorithm requires a large amount of training data to optimize training parameters. However, due to limitations in obtaining training data in a specific channel environment, a large amount of training data may be used offline. Such static training on data from a specific channel environment may cause a mismatch between the trained model and the dynamic and diverse nature of wireless channels.

Second, current deep learning mainly targets real signals. However, physical layer signals in a wireless communication system are complex signals. Therefore, further research is needed on a neural network that detects complex-valued signals in order to adapt deep learning to the characteristics of wireless communication signals.

Hereinafter, machine learning is described.

Machine learning may refer to a series of operations that train a machine to perform tasks that a human can do or tasks that are difficult for a human to do. For machine learning, data and a learning model are required. The learning methods for machine learning may be broadly classified into three categories. More specifically, the learning methods may be classified into supervised learning, unsupervised learning, and reinforcement learning.

A general learning procedure of a neural network may be to minimize the error of the output of the neural network. The learning of the neural network may be performed through the following procedures. First, learning of the neural network may repeatedly input training data into the neural network and obtain the output of the neural network for the training data. Second, the error between the output of the neural network and the target may be calculated. Third, the error may be backpropagated from the output layer to the input layer of the neural network in a direction to reduce the error, and the weights of respective nodes in the neural network may be updated. The neural network learning procedure may be performed through the series of procedures described above.

Supervised learning may be a method that uses training data with labeled correct answers. Unsupervised learning may be a method that uses training data without labeled correct answers. For example, in supervised learning for data classification, the training data may be data in which each training data sample is labeled with a category. The labeled training data may be input into the neural network. In supervised learning, the neural network may calculate an error by comparing the output (category) of the neural network with the label of the training data. The calculated error may be backpropagated in the neural network in a reverse direction (i.e. from the output layer to the input layer). The connection weights between nodes constituting each layer of the neural network may be updated according to the backpropagation of the error calculated in the neural network. The amount of change in the updated connection weights of nodes may be determined based on a learning rate. The calculation of the neural network for the input data and the backpropagation of the error may constitute a learning cycle (epoch). The learning rate may be applied differently depending on the number of repetitions of the learning cycle of the neural network. For example, in the early stage of learning of the neural network, a high learning rate may be used so that the neural network quickly achieves a certain level of performance to improve efficiency. In the later stage of learning of the neural network, a low learning rate may be used to improve the accuracy of the neural network.

The learning method described above may vary depending on the characteristics of the data. For example, in a case where the goal is for a receiving node to accurately predict data transmitted by a transmitting node in a communication system, it may be preferable to perform learning using supervised learning rather than unsupervised learning or reinforcement learning.

A learning model may correspond to a human brain, and the most basic linear model may be considered. Artificial neural networks, which are recently used as learning models, may be learning models having a neural network structure with high complexity. A machine learning paradigm with a neural network structure of such high complexity may be referred to as deep learning.

Neural network cores used for learning may be broadly classified into deep neural networks (DNNs), convolutional neural networks (CNNs), and recurrent neural networks (RNNs). The AI/ML described below may utilize learning models such as DNNs, CNNs, and RNNs.

An AI/ML framework is described below.

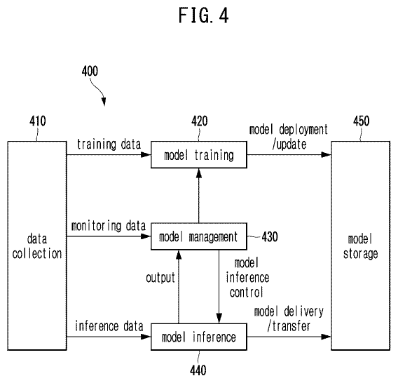

FIG. 4 is a conceptual diagram illustrating an example of an AI/ML framework according to an exemplary embodiment of the present disclosure.

Referring to FIG. 4, an AI/ML framework 400 may include a data collection device 410, a model training device 420, a model management device 430, a model inference device 440, and a model storage device 450. The model described in FIG. 4 may refer to an AI/ML model. The AI/ML framework 400 illustrated in FIG. 4 is merely an example, and the AI/ML framework should not be understood as being limited to the example shown in FIG. 4. For example, various entities and/or functions and/or devices not illustrated in FIG. 4 may be added to the AI/ML framework 400. In another example, some of the devices illustrated in FIG. 4 may be omitted.

The data collection device 410 may provide, discard, or update collected data for various purposes such as model training, model inference, model monitoring, model selection, and model updating in life cycle management (LCM) of the collected data, and may provide the data to other devices. The data collection device 410 in FIG. 4 may be a conceptual device. The data collection device 410 may store data collected for training, inference, and monitoring. Therefore, the data collection device 410 may be understood as data sources and entities that hold the data. In the example of FIG. 4, the data collection device 410 is illustrated as a single device for convenience of description and understanding. However, data collection for model training, model inference, and monitoring may have various characteristics and requirements. In addition, time scales for training and monitoring may require separate considerations. The time scales for training and monitoring may require various considerations, for example, whether the data collection is performed in real time or offline. Based on such considerations and requirements, a plurality of data collection devices may be configured.

With respect to training, training data may be initially generated in a network and a UE. The initial data may be collected (or transmitted) by one or more data collection entities (e.g. the data collection device 410). The data collection entities may be owned by various parties such as internal or external UE/chipset/network vendors, network operators, and positioning service providers.

With respect to inference, inference data for a UE-side model and/or for a UE-side portion of a two-sided model may be directly transmitted or provided from the UE to the data collection device 410. Inference data for a network-side model and/or for a network-side portion of a two-sided model may be directly transmitted or provided from the network to the data collection device 410, or may be transmitted from the UE to the data collection device 410.

With respect to monitoring, monitoring data for UE-side monitoring may be directly transmitted or provided from the UE to the data collection device 410. Monitoring data for network-side monitoring may be directly transmitted or provided from the network to the data collection device 410, or may be transmitted from the UE to the data collection device 410.

Data collection for real-time model monitoring, switching, and selection may cause significant signaling overhead. Conversely, when infrequent data collection is used to reduce signaling overhead, latency issues may arise for real-time model monitoring, switching, and selection.

The model training device 420 may be a device that performs both initial training and model updating. Generally, model training may be divided into model training performed during model development and subsequent training performed on a developed model. It should be noted that the model training device 420 of FIG. 4 is illustrated as a single block for simplification. In other words, the model training device 420 illustrated in FIG. 4 may include a first model training device that performs model training during model development and a second model training device that performs subsequent training on a developed model.

Depending on the location of a data set and/or the region where a model (or an untrained model) is located, training may be performed by an internal network entity or by an external entity such as a UE/chipset/network vendor, network operator, or positioning service provider. AI/ML model development may generally be an iterative process of data collection, model design, training, and performance verification. Therefore, AI/ML model development may require careful implementation considerations regarding power consumption for AI/ML model development, hardware area, latency, and concurrency with other layer functions.

When large-scale field data is collected at a data collection entity, a supplier responsible for model development needs to be able to use the collected data. Generally, model development is performed as an offline engineering process by an engineering team that needs to access the large-scale field data set collected in the field. In other words, decisions on the model architecture, device-specific optimizations, and the number of models to be developed (e.g. whether generalized or specific models) may vary depending on the large-scale field data. When a supplier owning the data collection entity is different from a supplier responsible for model development, the supplier responsible for model development needs to be able to use the data set. This may be achieved through explicit data set sharing or by providing access to the collected data set. Data set sharing or access may be related to two-sided models in which both a gNB supplier and a UE/chipset supplier participate in the model development and training process.

After a model is developed and trained, the model may be stored in a model repository or model storage device 450, and may be transferred to a target device. The model may be compiled into an executable file for inference. Here, various methods may exist depending on where the model is trained, a model storage/transfer format, and where the model is hosted before transfer.

The model inference device 440 may provide an AI/ML model inference output by performing prediction or decision making for a specific time using the model. The model inference device 440 may also provide model performance feedback to the model training device 420. The model inference device 440 may perform data preparation, such as data preprocessing, cleaning, formatting, and transformation, based on inference data provided by the data collection device 410.

The model management device 430 may perform operations such as functionality/model monitoring, selection, activation, deactivation, switching, and fallback. FIG. 4 illustrates an example of the model management device 430. However, not all aspects of the model management device 430 are necessarily implemented in a single location. Some aspects of model monitoring, activation/deactivation, selection, switching, and fallback may be performed on a network side, and other aspects may be performed on a UE side. Regarding model selection, activation, deactivation, switching, and fallback for UE-side models and for two-sided models, mechanisms may be considered for network-initiated decisions by the network, mechanisms for network-initiated decisions requested by the UE, mechanisms for UE-initiated decisions triggered by network-configured events and reported to the network, mechanisms for UE-autonomous decisions reported to the network, and mechanisms for UE-autonomous decisions not reported to the network.

An AI/ML-based beam management procedure may be introduced in next-generation wireless communication systems. The beam management procedure may include a measurement procedure based on a specific beam set and an inference procedure based on measurement results for the beam set. A beam set related to measurement for an AI/ML model and a beam set related to inference for the AI/ML model (or a set of beams to be predicted) may differ. In the present disclosure, the beam set related to beam measurement for the AI/ML model is referred to as ‘Set B’ or ‘Set B list’, and the beam set related to inference (or the set of beams to be predicted) is referred to as ‘Set A’ or ‘Set A list’. In addition, the AI/ML model in the present disclosure may refer to a specific AI model or a specific ML model. In other words, when only AI is described, it may be understood as ML or as AI/ML. When only ML is described, it may be understood as AI or as AI/ML. When AI/ML is described, it should be noted that it may be understood as AI or as ML.

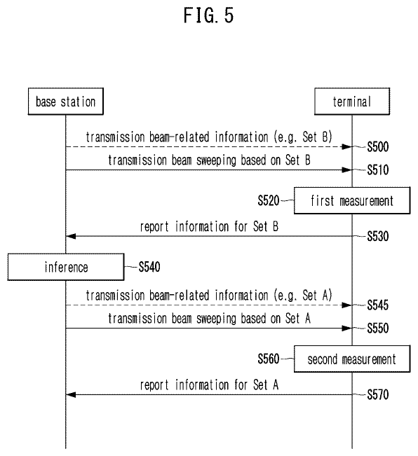

FIG. 5 is a sequence chart illustrating a beam management procedure between a base station and a terminal when the base station performs inference in a mobile communication system.

The base station illustrated in FIG. 5 may include all or part of the components of the communication node 200 described above with reference to FIG. 2. The base station may further include one or more of an interface for communication with the core network, an operator interface, and an interface for communication with another base station, in addition to the components of the communication node 200 illustrated in FIG. 2. The terminal may also include all or part of the components of the communication node 200 described above with reference to FIG. 2. The terminal may further include additional components. For example, the terminal may further include a user interface for user convenience and one or more of various sensors. The terminal illustrated in FIG. 5 may have one of various types described in FIG. 2, for example, a UE, an access terminal, a mobile terminal, or a station.

In step S500, the base station may transmit transmission beam-related information to the terminal. The transmission beam-related information may be information on Set B or Set B list, which is a beam set related to measurement. The procedure of step S500 may be performed using a higher-layer signaling message (e.g. radio resource control (RRC) signaling message and/or a medium access control (MAC) signaling message). Therefore, the terminal may receive the transmission beam-related information from the base station. The transmission beam-related information may include information a start time of Set B or Set B list. Since Set B (or Set B list) is a set of beams for measurement, it may be understood in the same manner as in a case where the terminal acquires channel state information (CSI) by measuring the beams. For example, Set B (or Set B list) configured by the base station may be determined based on a start time of a CSI framework used in 5G NR. Each downlink (DL) beam included in Set B may be assigned a beam identifier (ID). Each beam or beam ID may be associated with an AI/ML model ID described below.

Meanwhile, in FIG. 5, the transmission beam-related information may not necessarily be transmitted through a separate signaling message. The base station may generally sweep beams to find beams for communication. Therefore, in a case where such a beam sweeping scheme is used, the transmission beam-related information, that is, information on Set B, may not be transmitted. Step S500 may or may not be performed depending on technical specifications. Step S500 in FIG. 5 may be configured to be performed or not performed. It should be noted that in FIG. 5, step S500 is indicated with a dotted line to represent this possibility.

In step S510, the base station may sweep the transmission beams of Set B and broadcast (or transmit) the beams to terminals within a cell. When step S500 is performed, the base station may sweep the transmission beams of Set B in step S510 based on the transmission beam-related information transmitted to the terminal. Each of the swept transmission beams may include a reference signal (RS) for beam measurement or a pre-configured signal for beam measurement. In step S510, the terminal may receive one or more beams among the transmission beams of Set B swept and transmitted by the base station. When receiving the transmission beams of Set B swept and transmitted by the base station, the terminal may sweep reception beams of the terminal.

In step S520, the terminal may perform a first measurement. The first measurement in step S520 may be performed when a preconfigured condition is satisfied. The preconfigured condition may be determined based on configuration information of the base station. This is described in more detail below. When the preconfigured condition is satisfied, the terminal may receive the transmission beams of Set B in step S510 and may perform step S520. In the present disclosure, the first measurement may be a procedure of measuring each of the beams received by the terminal among the transmission beams of Set B swept and broadcast (or transmitted) by the base station. Depending on a radio channel environment between the terminal and the base station, the terminal may not be able to receive all of the transmission beams of Set B swept and broadcast (or transmitted) by the base station. Therefore, the number of beams on which the first measurement is performed at the terminal may be equal to or smaller than the number of transmission beams of Set B swept and broadcast (or transmitted) by the base station.

The present disclosure does not impose particular limitations on a measurement method for each beam. For example, the measurement method for each beam may acquire one of a reference signal received power (RSRP), a reference signal received quality (RSRQ), a received signal strength indicator (RSSI), or a signal-to-interference-and-noise ratio (SINR) through measurement. The measurement method for each beam in the present disclosure is merely an example and should not be construed as being limited thereto.

In step S530, the terminal may configure measurement results for the transmission beams of Set B as report information for Set B and may transmit a report message including the report information for Set B to the base station. Therefore, the report message for Set B may include the measurement result for each of the transmission beams of Set B. The base station may receive the report message for Set B from the terminal in step S530. The report message for Set B (or Set B list) may be configured based on the information configured by the base station in step S500. The method and configuration information of configuring the report message are described in more detail below.

In step S540, the base station may perform inference based on the report information for Set B. An input of the inference may be the report information for Set B. An output of the inference may be one or more beams and/or a beam set to be used when the base station performs downlink transmission to the terminal. The one or more beams and/or the beam set to be used when performing downlink transmission may be Set A or Set A list described above.

In step S545, the base station may transmit transmission beam-related information to the terminal. The transmission beam-related information transmitted in step S545 may be information on Set A or Set A list. The transmission beam-related information may include information on a start time of Set A or Set A list. Since Set A (or Set A list) is a set of beams for inference, and CSI is inferred using an RS transmitted through each beam, it may be understood in the same manner as in a case where CSI is acquired. For example, Set A (or Set A list) configured by the base station may be determined based on a start time of a CSI framework used in 5G NR. Each downlink (DL) beam included in Set A may be assigned a beam ID. Each beam or beam ID may be associated with an AI/ML model ID described below.

Therefore, the terminal may receive the transmission beam-related information from the base station in step S545. As described above with respect to step S500, step S545 may be performed or may be configured not to be performed. It should be noted that in FIG. 5, step S545 is indicated with a dotted line to represent this possibility.

In step S550, the base station may sweep transmission beam(s) of Set A and transmit the beam(s) to the terminal. As described in step S510, the transmission beam(s) of Set A swept in step S550 may transmit an RS for measurement of the transmission beam(s) of Set A. Therefore, in step S550, the terminal may receive the transmission beam(s) of Set A swept by the base station.

In step S560, the terminal may perform a second measurement. In the present disclosure, the second measurement may be a procedure for measuring the transmission beams of Set A swept and transmitted by the base station. The present disclosure does not impose particular limitations on the measurement method for the beam(s). The measurement method for each of the beams may be a method of acquiring one of RSRP, RSRQ, RSSI, or SINR through measurement, as described above. The measurement method for each of the beams in the present disclosure is merely an example and should not be construed as being limited thereto.

In step S570, the terminal may configure measurement results for the transmission beam(s) of Set A as report information for Set A and may transmit the report information for Set A to the base station. The report information for Set A may include measurement results for the transmission beams of Set A. The base station may receive the report information for Set A from the terminal in step S570.

It should be noted that procedures after step S570 are not illustrated in the sequence chart of FIG. 5. The base station may determine a beam to be used for downlink transmission based on the report information for Set A. In receiving the beam for Set A transmitted by the base station, the terminal may perform reception beam sweeping to receive the beams for Set A. The terminal may determine a reception beam to be used for receiving during downlink transmission by the base station.

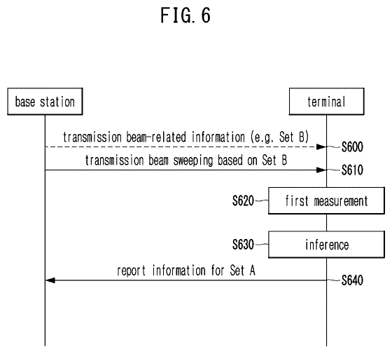

FIG. 6 is a sequence chart illustrating a beam management procedure between a base station and a terminal when the terminal performs inference in a mobile communication system.

The base station illustrated in FIG. 6 may include all or part of the components of the communication node 200 described above with reference to FIG. 2. The base station may further include one or more of an interface for communication with the core network, an operator interface, and an interface for communication with another base station, in addition to the components of the communication node 200 illustrated in FIG. 2. The terminal may also include all or part of the components of the communication node 200 described above with reference to FIG. 2. The terminal may further include additional components. For example, the terminal may further include a user interface for user convenience and one or more of various sensors. The terminal illustrated in FIG. 6 may have one of various types described in FIG. 2, for example, a UE, an access terminal, a mobile terminal, or a station.

In step S600, the base station may transmit transmission beam-related information to the terminal. The transmission beam-related information may be information on Set B or Set B list, which is a set of beams related to measurement. The procedure of step S600 may be performed through a higher-layer signaling (e.g. RRC signaling message and/or MAC signaling message). The terminal may receive the transmission beam-related information from the base station. The transmission beam-related information may include information on a start time of Set B or Set B list. Since Set B (or Set B list) is a set of beams for measurement, it may be understood in the same manner as in a case where the terminal acquires CSI by measuring the beams. For example, Set B (or Set B list) configured by the base station may be determined based on a start time of a CSI framework used in 5G NR. Each DL beam included in Set B may be assigned a beam ID. Each beam or beam ID may be associated with an AI/ML model ID described below.

Meanwhile, in FIG. 6, the transmission beam-related information may not necessarily be transmitted through a separate signaling message. The base station may generally sweep beams to find beams for communication. Therefore, in a case where such a beam sweeping scheme is used, the transmission beam-related information, that is, information on Set B, may not be transmitted. Step S600 may or may not be performed depending on technical specifications. Step S600 in FIG. 6 may be configured to be performed or not performed. It should be noted that in FIG. 6, step S600 is indicated with a dotted line to represent this possibility.

In step S610, the base station may sweep the transmission beams of Set B and broadcast (or transmit) the beams to terminals within a cell. When step S600 is performed, the base station may sweep the transmission beams of Set B in step S610 based on the transmission beam-related information transmitted to the terminal. Each of the swept transmission beams may include an RS for beam measurement. In step S610, the terminal may receive one or more beams among the transmission beams of Set B swept and transmitted by the base station. When receiving the transmission beams of Set B swept and transmitted by the base station, the terminal may sweep reception beams of the terminal.

In step S620, the terminal may perform a first measurement. The first measurement in step S620 may be performed when a preconfigured condition is satisfied. The preconfigured condition may be determined based on configuration information of the base station. This is described in more detail below. When the preconfigured condition is satisfied, the terminal may receive the transmission beams of Set B in step S610 and may perform step S620. In the present disclosure, the first measurement may be a procedure of measuring each of the beams received by the terminal among the transmission beams of Set B swept and broadcast (or transmitted) by the base station. The present disclosure does not impose particular limitations on a measurement method for each beam. For example, the measurement method for each beam may refer to a procedure of measuring one of an RSRP, RSRQ, RSSI, or SINR. The measurement method for each beam in the present disclosure is merely an example and should not be construed as being limited thereto. Depending on a radio channel environment between the terminal and the base station, the terminal may not be able to receive all of the transmission beams of Set B swept and broadcast (or transmitted) by the base station. Therefore, the number of beams for which the first measurement is performed at the terminal may be equal to or smaller than the number of transmission beams of Set B swept and broadcast (or transmitted) by the base station.

In step S630, the terminal may perform inference based on the results of the first measurement. An input of the inference may be the measurement results for the beams of Set B or processed information of the measurement results for the beams of Set B. An output of the inference may be one or more beams and/or a beam set to be used when the base station performs DL transmission to the terminal. The one or more beams and/or the beam set to be used when performing DL transmission may be Set A or Set A list described above. Set A (or Set A list) may include results predicted based on the inference by the AI/ML model of the terminal. The prediction results may include one or more DL beams and/or information related to the DL beams. The prediction results based on the inference by the AI/ML model of the terminal may be one or more DL beams and/or information related to the DL beams to be used at a specific future time. The base station may configure information on future times to be reported by the terminal. The information on the future times may include a time interval for reporting based on the inference and/or a number N (N is a natural number) of future times to be inferred. The number of future times to be inferred may be determined by the base station according to a requirement of the base station and/or an accuracy of the AI/ML model. In addition, when each inferred future time is referred to as a time instance, a reference time for the time instances may also be configured by the base station. The reference time of the earliest time instance of the prediction results based on the inference may also be configured by the base station.

For example, the terminal may be carried and moved by a user. For example, the AI/ML model may predict a location of the terminal at a future time by using at least one piece of information among a direction, a speed, and/or map data of the user. In other words, the terminal may predict the location of the terminal at 10 ms, 20 ms, and 30 ms after the current time by using history information and/or map information, and the AI/ML model may infer information on DL beam(s) to be used at each of 10 ms, 20 ms, and 30 ms. In the above example, the time interval may be 10 ms, and N may be 3.

In another example, when the terminal remains at a fixed location, the AI/ML model may infer information on DL beam(s) to be used at each of 10 ms, 20 ms, and 30 ms later. Here, 10 ms, 20 ms, 30 ms, and the like are merely an example for describing a prediction time interval after a specific time in the inference results of the AI/ML model in the present disclosure, and are not limited thereto. In other words, the AI/ML model may infer results for future times such as 1 second, 2 second, 3 second, and the like, or for future times such as 5 second, 10 second, 15 second, and the like.

In step S640, the terminal may transmit to the base station a report message configured with results inferred for the transmission beam(s) of Set A as report information for Set A. The report information for Set A may include inference results for the transmission beams of Set A. The report information for Set A may be configured through a CSI-ReportConfig information element (IE) to be described below. The base station may receive a report message including the report information for Set A from the terminal in step S640.

It should be noted that procedures after step S640 are not illustrated in the sequence chart of FIG. 6. The base station may determine a beam to be used for DL transmission based on the report information for Set A. In addition, when receiving the beams for Set B transmitted by the base station, the terminal may sweep reception beams to receive each of the beams of Set B. When receiving each of the beams of Set B, the terminal may store information on a reception beam corresponding to each of the beams of Set B. When beams belonging to Set A, which are inference results based on the AI/ML model, are determined, the terminal may determine reception beams respectively corresponding to the beams included in Set A based on previously stored information on reception beams or may determine the reception beams by using a separate AI/ML model. Through this, when the base station performs DL transmission by using the beams for Set A, the terminal may determine reception beam(s) to be used.

The procedures of FIG. 5 and/or FIG. 6 described above may be performed in the following cases. First, the procedures of FIG. 5 and/or FIG. 6 may be performed during an initial access and/or random access procedure. Second, the procedures of FIG. 5 and/or FIG. 6 may be performed during a synchronization procedure between the terminal and the base station. Third, the procedures of FIG. 5 and/or FIG. 6 may be performed during a beam recovery procedure. Fourth, the procedures of FIG. 5 and/or FIG. 6 may be performed during RRC connection establishment. Fifth, the procedures of FIG. 5 and/or FIG. 6 may be performed during RRC reconfiguration. Sixth, the procedures of FIG. 5 and/or FIG. 6 may be performed by an instruction (or request) of the base station (or the network). Seventh, the procedures of FIG. 5 and/or FIG. 6 may be performed by a request of the terminal.

Hereinafter, methods proposed by the present disclosure are described. The methods described below may be applied to the methods described in FIG. 5 and/or FIG. 6 described above.

According to an exemplary embodiment of the present disclosure, the configured Set A (or Set A list) and/or Set B (or Set B list) may be configured together with an AI/ML ID (or AI/ML model ID). When Set A and/or Set B are configured together with an AI/ML ID, each of a plurality of Set A and a plurality of Set B may be configured together with an AI/ML ID. When a plurality of Set A lists and a plurality of Set B lists are configured, the base station may transmit one or more Set A IDs and one or more Set B IDs to be used by the terminal. When one Set A and one Set B may be paired and configured with one ID, one or more paired IDs may be transmitted to the terminal. The configurations described below are assumed to be consistent at least within one cell.

When a specific AI/ML model is trained and updated at the terminal, the base station may provide a data collection-related configuration and a corresponding AI/ML model ID to the terminal in order to collect data trained and updated at the terminal. The terminal may receive the data collection-related configuration and the corresponding AI/ML model ID transmitted by the base station and may report the data trained and updated for the corresponding AI/ML model together with the AI/ML model ID to the base station.

Meanwhile, for inference related to measurements of neighboring cells of the base station (e.g. interference measurement, handover, cell selection, etc.), the base station may transmit, to a served terminal, one or more of the following: Set A list of a neighboring cell, Set B list of the neighboring cell, an AI/ML ID of the neighboring cell (e.g. identifier for identifying AI/ML based on a model, functionality, mode, entity, purpose, etc.), the number of beams in the Set A and/or Set B of the neighboring cell, and time-related information for training and/or inference.

Unlike the cases described above, the configured Set A (or Set A list) and/or Set B (or Set B list) may also be configured independently of the AI/ML ID.

When the terminal utilizes acquired measurement values in an inference procedure and/or in a training procedure for inference according to the present disclosure, a valid duration for the measurement values may be configured. For example, when the terminal utilizes measurement values at a time T(n), measurement values acquired up to a time T(n−Vk) may be utilized. The value Vk may be a parameter indicating a valid time duration for the measurement values. The base station may configure the Vk value together with the AI/ML ID in an RRC signaling message and may transmit the message to the terminal. In another example, the base station may configure the Vk value and the AI/ML ID independently in RRC signaling messages and may transmit the messages to the terminal. Therefore, the terminal may receive the RRC signaling message(s) from the base station and may acquire the Vk value and the AI/ML ID from the RRC signaling message(s).

When the Set A and/or Set B list is changed within the valid time duration indicated by the Vk value, the terminal may ignore the Vk value received before the change of the Set A and/or Set B list, and may utilize only the measurement values after the change of the Set A and/or Set B list. The Vk value may be changed according to a buffer status of the terminal. In addition, the Vk value may be changed by a request of the terminal and/or by an instruction of the base station.

When the terminal reports an inference value (or an output of the inference) to the base station according to the present disclosure, other inference values of the same type may be configured in one report message in temporal order, and one message including a plurality of inference values may be reported to the base station at once by the terminal.

This is described in further detail. The terminal may acquire a plurality of inference values in temporal order through the AI/ML model. In other words, the terminal may perform inference a plurality of times, and may output an inference value at each inference. Therefore, inference values output at the times of the respective inferences may have a temporal order. For example, assuming that inferences are performed in a time flow of t1→t2→t3→t4, the terminal may acquire a plurality of inference values in temporal order, such as an inference value #1 acquired through inference at the time t1, an inference value #2 acquired through inference at the time t2, an inference value #3 acquired through inference at the time t3, and an inference value #4 acquired through inference at the time t4. The terminal may configure the inference value #1, inference value #2, inference value #3, and inference value #4 in temporal order in one report message. The terminal may transmit the one report message to the base station.

When it is not possible to include and transmit all inference values within the size of one report message, the terminal may configure the report message based on inference report message configuration information received from the base station. The inference report message configuration information may be transmitted from the base station to the terminal through an RRC signaling message. The inference report message configuration information may be configured to include one or more of the following.
1) information on a time (e.g. time instance) for each inference value
2) time interval of inference values
3) reference time of the first inference value (a reference time at which inference starts first among a plurality of inferences) among the inference values
4) reference time of the last inference value (a reference time at which inference starts last among a plurality of inferences) among the inference values

The inference report message configuration information may further include information on how many inference values in temporal order are to be reported through one inference report message. In another example, the inference report message configuration information may further include information instructing the terminal to report only a certain number of top-ranked inference values (e.g. predicted beams). The number of inference values may be configured by time instance indicators. The number N (N is a natural number) of time instance indicators may have a value of 1 or greater than 1. The value of the time instance indicator may correspond to the earliest time instance.

In addition, the inference report message configuration information may be configured together with an AI/ML ID in an RRC signaling message, or may be configured independently of the AI/ML ID. The inference report message configuration information may be configured in a cell-specific manner. In another example, the inference report message configuration information may be updated in a UE-specific manner. The inference report message configuration information may be determined based on whether the terminal is capable of using an AI/ML model and whether the terminal has a capability to report a plurality of inference values. Whether the terminal is capable of using an AI/ML model and whether the terminal has a capability to report a plurality of inference values may be reported to the base station together with AI/ML model information or may be reported independently.

The terminal may configure one inference report message based on the inference report message configuration information and may transmit the inference report message to the base station. When two or more inference values are included in the inference report message, the two or more inference values may be configured in temporal order.

Meanwhile, in the present disclosure, the AI/ML IDs may have different IDs depending on models, functionalities, modes, entities, and purposes. Here, the model may represent an AI/ML model (AI/ML model for data collection, measurement, training, and inference), and information on the model may include a function value of the AI model and/or input/output values for training of the AI model and/or input/output values for inference of the AI model. The functionality may represent a purpose of using AI/ML (e.g. beam management, channel information estimation, location information estimation, handover, radio link failure, etc.). The mode may represent a scheme for data collection, measurement, training, and inference distinguished within the functionality. The entity may indicate an entity that performs data collection, measurement, training, and/or inference, and may represent whether the operation is performed at the base station, at the terminal, or at both. The purpose may indicate an association relationship between data collection and/or measurement and/or training and/or inference procedures. For example, the information on the purpose may indicate that data collection and inference are related to each other. The AI/ML ID may be configured as an identifier other than an AI/ML ID (e.g. model ID and purpose ID) depending on the model, functionality, mode, entity, and purpose. The AI/ML ID may be configured in an RRC signaling message and may be transmitted to the terminal. In another example, the AI/ML ID may be included in a MAC control element (CE) and/or downlink control information (DCI) and may be transmitted to the terminal.

In the present disclosure, time for each inference value output by the AI/ML model may be preconfigured. The time for each inference value output by the AI/ML model may be configured to the terminal by the base station through inference configuration information. The time for each inference value output by the AI/ML model may be configured to include one or more of the following.
1) time (output time) for each inference value output by the AI/ML model
2) time interval between inference values output by the AI/ML model
3) reference time of the first inference value among the inference values output by the AI/ML model
4) reference time of the last inference value among the inference values output by the AI/ML model

The time exemplified in 1) to 4) may be configured in units of frame (or subframe), slot, second(s), or millisecond(s).

When a time interval is not configured to the terminal, the terminal may assume a continuous time interval (e.g. 1).

The time information for the inference values included in the inference configuration information may be configured through a time instance indicator. N (N is 0 or a natural number) time instance indicators may be configured. The time instance indicator may correspond to a time instance corresponding to the earliest of the configured inference time(s).

When the time is preconfigured for each inference value output by the AI/ML model as described above, the terminal may transmit a report message to the base station including one or more of time for each inference value, time interval, reference time of the first inference value among the inference values, or reference time of the last inference value among the inference values.

Hereinafter, CSI report configuration associated with an AI/ML ID and/or with a model, functionality, mode, entity, and purpose of AI/ML is described by using information elements defined in the 5G NR technical specifications. The following examples are provided to aid understanding of the present disclosure and should not be construed as being limited thereto.

The CSI report configuration associated with an AI/ML ID and/or with a model, functionality, mode, entity, and purpose of AI/ML may be configured through a CSI-ReportConfig IE. In other words, a terminal that receives a CSI-ReportConfig IE may configure a report message based on information included in the CSI-ReportConfig IE. According to an exemplary embodiment of the present disclosure, the CSI-ReportConfig IE may be measurement report configuration information and/or inference report configuration information.

In one example, the CSI-ReportConfig may include report configuration information for Set B. In another example, the CSI-ReportConfig may include report configuration information for Set A.

In another example, the CSI-ReportConfig may include report configuration information for both Set B and Set A, respectively. When the CSI-ReportConfig includes report configuration information for both Set B and Set A, a CSI-ReportConfig identifier (CSI-ReportConfigId) corresponding to Set B and a CSI-ReportConfig identifier (CSI-ReportConfigId) corresponding to Set A may be different from each other.

In another example, one CSI-ReportConfig applicable to both Set B and Set A may be configured. When one CSI-ReportConfig applicable to both Set B and Set A is configured, one CSI-ReportConfig identifier (CSI-ReportConfigId) may be configured.

In another example, a CSI-ReportConfig identifier (CSI-ReportConfigId) corresponding to Set B may be configured, and Set A may be configured using a separate resource set other than the resources represented by the CSI-ReportConfigId corresponding to Set B.

Based on the CSI-ReportConfig IE described above, the terminal may perform measurement for beams of Set B. The terminal may perform inference for Set A based on the CSI-ReportConfig IE.

The terminal may identify a report configuration type (reportConfigType) IE included in the CSI-ReportConfig. The reportConfigType IE may include the following parameters, and the terminal may acquire the following parameters.
a) periodic parameter
b) semiPersistentOnPUCCH parameter
c) semiPersistentOnPUSCH parameter
d) aperiodic parameter

The terminal may interpret (identify) one of time, time interval, reference time of the first inference value, or reference time of the last inference value based on the parameters a) to d) above.

As described above, the terminal may sequentially arrange the inference values output in temporal order by the AI/ML model and may report the inference values to the base station in time order. Such reporting may be performed in the manner described above.

For example, the terminal may report inference values to the base station based on time corresponding to the inference values, such as frame (or subframe)-based time. In another example, the terminal may report inference values to the base station based on slot-based time corresponding to the inference values. In another example, the terminal may report inference values to the base station in units of seconds(s) or milliseconds (ms). In another example, the terminal may report inference values to the base station based on time resource units defined in the wireless communication system.

When reporting inference values to the base station at a specific period as described above, the terminal may report one or more of a time interval for the inference values, a reference time of the first inference value, or a reference time of the last inference value to the base station together with the inference values.

When reporting the inference values, the terminal may perform quantization for the inference values to configure a signal. In another example, the terminal may set an inference value at a specific time as a reference, and may configure other inference values as differences from the reference inference value to report them. For example, when the inference value is a first layer (Layer 1, L1) RSRP, the reference inference value may be a specific L1-RSRP value, and the inference values at each time may also be represented as L1-RSRP values. Therefore, the report information may be determined by difference values between the reference inference value of the L1-RSRP value and the inferred L1-RSRP values at the respective times. The L1-RSRP values (the reference inference value of L1-RSRP and each L1-RSRP value at the respective times) may be determined based on a range defined by quantization information specified in 5G NR. With respect to the inference value at a specific time (e.g. the reference inference value), the specific time may be the reference time of the first inference value or the reference time of the last inference value.

In addition, when necessary, the terminal may report inference values to the base station in an order of magnitude of the inference values instead of in time sequence. The reference time of the first inference value or the reference time of the last inference value may be a time corresponding to the largest inference value or the smallest inference value.

As described above, when inference values based on a time instance indicator are transmitted through a CSI field, a size of the CSI field for the time instance indicator may be determined based on the number N of the time instance indicators. For example, the size of the CSI field for the time instance indicator may be determined according to Mathematical Expression 1 below.

$$⌈ {log}_{2} N ⌉ \qquad [ Equation 1 ]$$

For training and/or inference, the base station may transmit at least one piece of information among a training start, training end, training duration, inference start, inference end, inference duration, or reference value for performance monitoring of inference to the terminal. At least part of the information transmitted by the base station may be configured in a cell-specific manner. For training and/or inference, at least part of the information transmitted by the base station may be updated in a UE-specific or group-specific manner. A group may be configured in various manners, such as a group composed of arbitrary UEs, a group of UEs using the same AI, or a group of UEs using the same model.

For training and/or inference, at least part of the information transmitted by the base station may be configured in a UE-specific or group-specific manner. When at least part of the information transmitted by the base station for training and/or inference is configured in a group-specific manner, the group-specific information may be applied to terminals using the same model or terminals using the same functionality, mode, entity, or purpose.

According to an exemplary embodiment of the present disclosure, training may be initiated based on an enable or activation indication through control information of MAC-CE or DCI. For example, when a MAC-CE received from the base station at a time t(n) or a DCI received from the base station indicates training, the terminal may start a training procedure from a time t(n+Tts). Tts may be a time offset for operation of the terminal, taking into account a time delay difference depending on a distance between the base station and the terminal and a hardware processing time after the terminal receives and recognizes the control signal.

In another example, an indication for training start may be transmitted as information indicating a start time when training starts relative to a reference time. When the base station indicates the time for training start to the terminal, the base station may need to configure the reference time. For example, the reference time may be determined as 00:00:00 on Jan. 1, 1900 (Sunday, Dec. 31, 1899 and Monday, Jan. 1, 1900 midnight) of the Gregorian calendar date. Therefore, the base station may indicate the training start time as a time that is a multiple of 10 ms from the reference time. In other words, when the base station indicates training start, the training start time field value may indicate a time configured as a multiple of 10 ms from the reference time. When training start is indicated, the terminal may start a training procedure based on the training start time field value.

According to an exemplary embodiment of the present disclosure, the training may be terminated based on a disable or deactivation indication or an indication of an end time through control information of MAC-CE or DCI. Therefore, a training duration may be a period from training start to training end, and the training duration may be determined based on units of frame (or subframe), slot, second(s) or millisecond(s), or based on time resource units defined in the wireless communication system. When the terminal receives information indicating training end, the terminal may terminate the training procedure. In another example, when the terminal receives information on the training duration, the terminal may terminate the training procedure when the training duration calculated from the training start time ends. In another example, when the terminal receives information indicating training end during the training duration, the terminal may terminate training.

Inference start, inference end, and inference duration may also be configured in the same manner as the training start, training end, and training duration. In other words, inference may be initiated based on an enable or activation indication through control information of MAC-CE or DCI, and a time offset for operation of the terminal may be configured, taking into account a time delay difference depending on a distance between the base station and the terminal and a hardware processing time after the terminal receives and recognizes the control signal. The time of inference start may also be configured through information on a start time when inference starts relative to a reference time.

The end time of inference may be determined based on a disable or deactivation indication or an indication of the end time through control information of MAC-CE or DCI. In another example, inference end may also be determined by the inference start time and the inference duration.

After receiving information on the inference start, inference end, and/or inference duration, the terminal may start and/or terminate the inference procedure. In another example, even when information on the inference start is not configured to the terminal, the terminal may start the inference procedure after training ends. In another example, during the inference duration, the terminal may monitor performance of inference, and when a monitoring result falls below a reference value (or threshold value) defined by the base station, the terminal may request inference termination to the base station or may transmit performance monitoring information to the base station. In another example, according to the AI/ML model, training may be performed together during the inference duration.

Regardless of the training duration or inference duration, when the terminal receives an on/off or activation/deactivation indication for AI/ML from the base station, the terminal may follow the indication.

Meanwhile, with respect to on/off or activation/deactivation of the AI/ML model, a holding time (duration) as described above may also be indicated depending on the model, functionality, mode, entity, or purpose. When the holding time expires (or elapses), the terminal may, in the absence of a specific indication, perform feedback in the original manner, continue maintaining the model, or request an indication from the base station. For example, when activation of a specific AI/ML model is indicated together with a holding time of the AI/ML model, the terminal may activate the AI/ML model. After the holding time of the AI/ML model is completed, the terminal may stop using the AI/ML model. When a specific indication (e.g. holding time extension of the AI/ML model or stop of the AI/ML model) is received from the base station during the holding time of the AI/ML model, the terminal may follow the indication received from the base station.

When a beam is utilized for data transmission, transmission configuration indication (TCI) information (e.g. information regarding a reference signal and quasi co-location (QCL) type) may be transmitted from the base station to the terminal. The TCI information may be configured based on RSs that constitute Set A or Set B list described above. In another method, the TCI information may be configured based on TCI IDs that constitute Set A or Set B list described above.

When information on an RS is configured as the TCI, the AI/ML ID may be configured together with the TCI. In another example, when the TCI information is transmitted to the terminal, the AI/ML ID may be transmitted together.

When the terminal has inferred values related to a plurality of beams in time sequence, the terminal may perform reception and/or transmission using the inferred beam mapped to a corresponding time of the inference result for a data channel and/or a control channel without TCI information from the base station. For a time duration of inference (or a time duration during which inference is performed), when there is no TCI configuration for the terminal from the base station, or when the base station transmits an indication to the terminal to follow the inference result, the terminal may apply the inferred beam.

For example, the terminal may apply an inferred beam from a time t(n+Ttb) after a time t(n) when the inference is performed. Ttb is a time offset for operation of the terminal, taking into account a time delay depending on a distance between the base station and the terminal, a hardware processing time for recognizing a control signal after receiving it at the terminal, and a holding time of the previous beam. When multiple beams are inferred, the terminal may follow a time (e.g. time configured in units of frames, subframes, or time resource units defined in the wireless communication system) corresponding to the inferred values, a time interval of the inferred values, or a beam holding time indicated by the base station.

When a beam failure occurs in the inferred time duration, the terminal may change a beam (e.g. transmission beam, reception beam, etc.) to the inferred beam and may notify the base station of the beam change. For example, when a beam failure occurs at a time t(n) and information on a beam inferred for a time t(n+k) exists, the terminal may change the beam to a beam at the time t(n+k) or to an optimal beam based on information on the inferred beam. The terminal may then notify the base station of the beam change.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a user equipment (UE), comprising:
receiving, from a base station, first configuration information including a first transmission beam set;
in response to a preconfigured condition being satisfied, receiving, from the base station, a reference signal (RS) through beams corresponding to the first transmission beam set;
generating measurement information for the RS received through each of the beams corresponding to the first transmission beam set;
generating a second transmission beam set based on the measurement information using an artificial intelligence (AI) model; and
reporting information on the second transmission beam set to the base station,
wherein the measurement information is an input of the AI model, and the second transmission beam set is generated through inference of the AI model.

2. The method according to claim 1, further comprising:
receiving downlink transmission beam information from the base station; and
receiving a downlink channel from the base station based on the downlink transmission beam information,
wherein the downlink transmission beam information indicates one or more beams selected from beams based on the information on the second transmission beam set.

3. The method according to claim 2, wherein the downlink transmission beam information is indicated based on transmission configuration indication (TCI) information.

4. The method according to claim 1, wherein the preconfigured condition is satisfied at least one of: when an initial access procedure is initiated, when synchronization between the UE and the base station is required, when a beam recovery procedure is initiated, when a radio resource control (RRC) connection establishment procedure is initiated, when an RRC reconfiguration is initiated, or when there is a request from the base station.

5. The method according to claim 1, wherein the first configuration information further includes at least one of: a time for each of inference values output by the AI model, a time interval between the inference values, a reference time of a first inference value among the inference values output by the AI model, or a reference time of a last inference value among the inference values output by the AI model.

6. The method according to claim 1, wherein the first configuration information further includes at least one of: an inference start time of the AI model, an inference end time of the AI model, an inference duration of the AI model, or a reference value for monitoring inference of the AI model.

7. The method according to claim 1, wherein when the first configuration information includes a plurality of first transmission beam sets, and activation indication information for one first transmission beam set among the plurality of first transmission beam sets is received, an RS is received from the base station through beams corresponding to the one first transmission beam set, and the AI model is an AI model corresponding to the one first transmission beam set indicated by the activation indication information among AI models configured by the first configuration information.

8. The method according to claim 7, further comprising: in response to receipt of deactivation indication information of the AI model corresponding to the one first transmission beam set for which the activation indication information is received, stopping the inference of the AI model.

9. The method according to claim 1, wherein when the measurement information, which is the input of the AI model, includes measurement values obtained using the AI model, the measurement information is determined based on a valid duration for the measurement values of the AI model, which is included in the first configuration information.

10. The method according to claim 1, wherein the first configuration information is determined in a UE-specific manner or in a manner specific to a UE group using a same AI.

11. A method of a base station, comprising:
transmitting, to a user equipment (UE), first configuration information including a first transmission beam set;
in response to a preconfigured condition being satisfied, transmitting a reference signal (RS) to the UE through beams corresponding to the first transmission beam set;
receiving, from the UE, information on a second transmission beam set;
transmitting, to the UE, information on a downlink transmission beam determined based on the second transmission beam set; and
transmitting a downlink channel to the UE through the determined downlink transmission beam.

12. The method according to claim 11, wherein the downlink transmission beam information is indicated based on transmission configuration indication (TCI) information.

13. The method according to claim 11, wherein the first configuration information further includes at least one of: a time for each of inference values output by the AI model, a time interval between the inference values, a reference time of a first inference value among the inference values output by the AI model, or a reference time of a last inference value among the inference values output by the AI model.

14. The method according to claim 11, further comprising: when the first configuration information includes a plurality of first transmission beam sets, and AI models are respectively configured for the plurality of first transmission beam sets, transmitting activation indication information for one first transmission beam set among the plurality of first transmission beam sets.

15. The method according to claim 11, wherein the first configuration information is determined in a UE-specific manner or in a manner specific to a UE group using a same AI.

16. A user equipment (UE) comprising at least one processor, wherein the at least one processor causes the UE to perform:
receiving, from a base station, first configuration information including a first transmission beam set;
in response to a preconfigured condition being satisfied, receiving, from the base station, a reference signal (RS) through beams corresponding to the first transmission beam set;
generating measurement information for the RS received through each of the beams corresponding to the first transmission beam set;
generating a second transmission beam set based on the measurement information using an artificial intelligence (AI) model; and
reporting information on the second transmission beam set to the base station,
wherein the measurement information is an input of the AI model, and the second transmission beam set is generated through inference of the AI model.

17. The UE according to claim 16, wherein the at least one processor causes the UE to perform:
receiving downlink transmission beam information from the base station; and
receiving a downlink channel from the base station based on the downlink transmission beam information,
wherein the downlink transmission beam information indicates one or more beams selected from beams based on the information on the second transmission beam set.

18. The UE according to claim 16, wherein the preconfigured condition is satisfied at least one of: when an initial access procedure is initiated, when synchronization between the UE and the base station is required, when a beam recovery procedure is initiated, when a radio resource control (RRC) connection establishment procedure is initiated, when an RRC reconfiguration is initiated, or when there is a request from the base station.

19. The UE according to claim 16, wherein the first configuration information further includes at least one of: a time for each of inference values output by the AI model, a time interval between the inference values, a reference time of a first inference value among the inference values output by the AI model, or a reference time of a last inference value among the inference values output by the AI model.

20. The UE according to claim 16, wherein the first configuration information further includes at least one of: an inference start time of the AI model, an inference end time of the AI model, an inference duration of the AI model, or a reference value for monitoring inference of the AI model.
